(19) United States
(12) Patent Application Publication
(10) Pub. No.: US 2026/0148019 A1
(43) Pub. Date: May 28, 2026

(54) SYSTEMS AND METHODS FOR UTILIZING TEXT MESSAGES TO INTERACT WITH VARIOUS SERVICES IN PLAIN LANGUAGE

(71) Applicant: Verizon Patent and Licensing Inc., Basking Ridge, NJ (US)

(72) Inventor: Ramayya DARBHAMULLA, Nashua, NH (US)

(73) Assignee: Verizon Patent and Licensing Inc., Basking Ridge, NJ (US)

(21) Appl. No.: 18/956,264

(22) Filed: Nov. 22, 2024

(51) Int. Cl. G06F 40/58; H04L 9/40

(52) U.S. Cl. CPC G06F 40/58; H04L 63/08

(57) ABSTRACT

A device may receive a message directed to a virtual ID number associated with a user equipment, and may translate the message into one or more commands. The device may identify one or more Internet of Things (IoT) devices associated with the one or more commands, and may provide the one or more commands to the one or more IoT devices. The device may receive feedback from the one or more IoT devices in response to the one or more commands, and may provide the feedback to the user equipment.

### BACKGROUND

Managing products and services on a smartphone requires users to navigate through multiple mobile or desktop applications, each with unique nuances, to control a limited range of functionality. One example would management of Internet of Things (IoT) devices within smart homes that require users to utilize proprietary systems offered by various vendors.

### BRIEF DESCRIPTION OF THE DRAWINGS

FIGS. 1A-1E are diagrams of an example associated with utilizing text messages to interact with smart devices in plain language.

FIG. 2 is a diagram of an example environment in which systems and/or methods described herein may be implemented.

FIG. 3 is a diagram of example components of one or more devices of FIG. 2.

FIG. 4 is a flowchart of an example process for utilizing text messages to interact with smart devices in plain language.

### DETAILED DESCRIPTION OF EXAMPLE EMBODIMENTS

The following detailed description of example implementations refers to the accompanying drawings. The same reference numbers in different drawings may identify the same or similar elements.

The fragmentation of IoT device management creates a challenging user experience as users must remember which application corresponds to each IoT device and specific procedures, passwords, and logins needed for IoT device operation. Moreover, understanding real-time statuses of different IoT devices is a daunting task for many users. Limited usage and adoption of the proprietary systems has led to a lack of an integrated, user-friendly solution that enables users to control and monitor their IoT devices through a simple and secure interface without a need to switch between multiple, often complex applications. Thus, current techniques for managing IoT devices consume computing resources (e.g., processing resources, memory resources, communication resources, and/or the like), networking resources, and/or other resources associated with navigating through multiple mobile or desktop applications to control IoT devices, utilizing proprietary IoT device management systems that are difficult to understand and operate, and/or the like.

Some implementations described herein provide a messaging system that utilizes text messages to interact with smart devices in plain language. For example, the messaging system may receive a text message directed to a virtual identification (ID) number associated with a user equipment (UE), and may translate the text message into one or more commands. The messaging system may identify one or more Internet of Things (IoT) devices associated with the one or more commands, and may provide the one or more proprietary commands, using the correct syntax or format to the one or more IoT devices. The messaging system may receive feedback from the one or more IoT devices in response to the one or more commands, and may provide the feedback to the UE.

In this way, the messaging system utilizes text messages to interact with smart devices in plain language. For example, the messaging system may identify IoT devices associated with a text message received from a user of a UE, may transmit specific commands to the IoT devices, and may relay a current status or feedback of the IoT device directly to the UE. The messaging system may translate the text message to the specific commands by utilizing a large language model (LLM), establishing a virtual ID number to securely authenticate user identity, and ensuring security checks for message authentication prior to execution of the specific commands. The messaging system may provide a unified interface through standard rich communication services (RCS) text messaging, and may enable streamlined control and management of diverse IoT devices. Thus, the messaging system may conserve computing resources, networking resources, and/or other resources that would have otherwise been consumed by navigating through multiple mobile or desktop applications to control IoT devices, utilizing proprietary IoT device management systems that are difficult to understand and operate, and/or the like. By simplifying technological interactions within IoT device ecosystems through a common, accessible communication mode, the messaging system may improve effectiveness and reduce technical complexities associated with IoT device management.

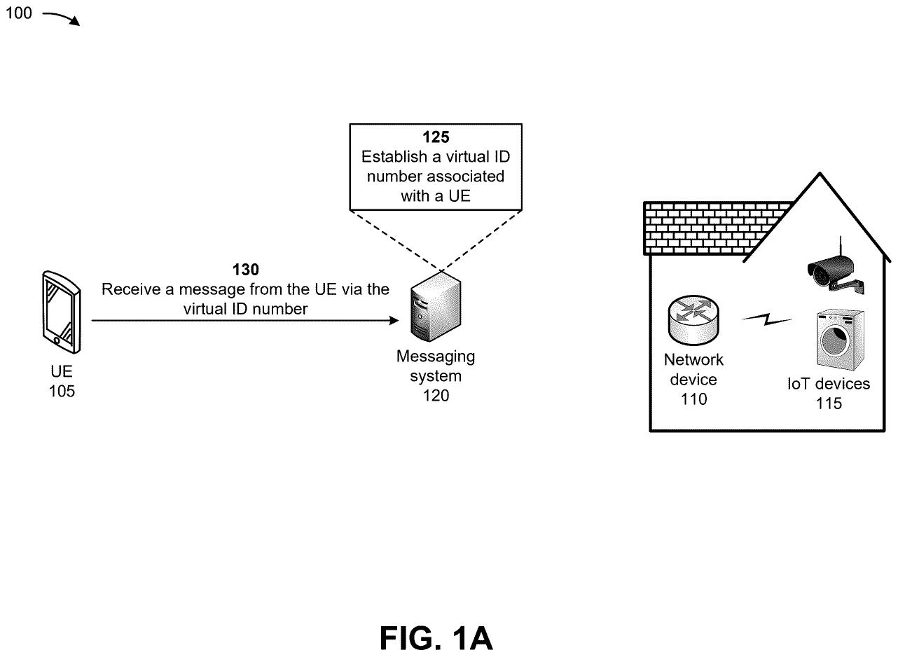

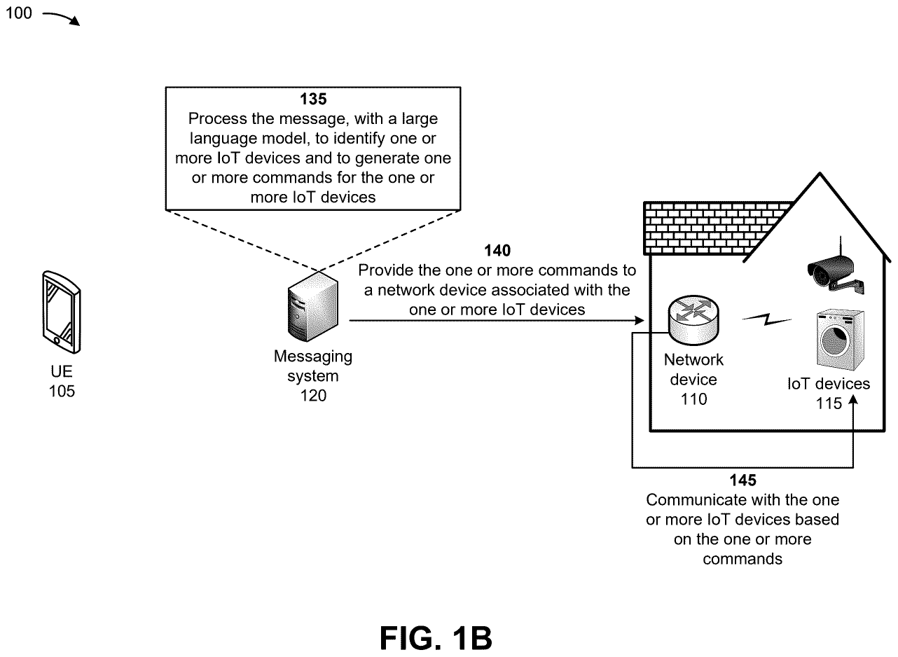

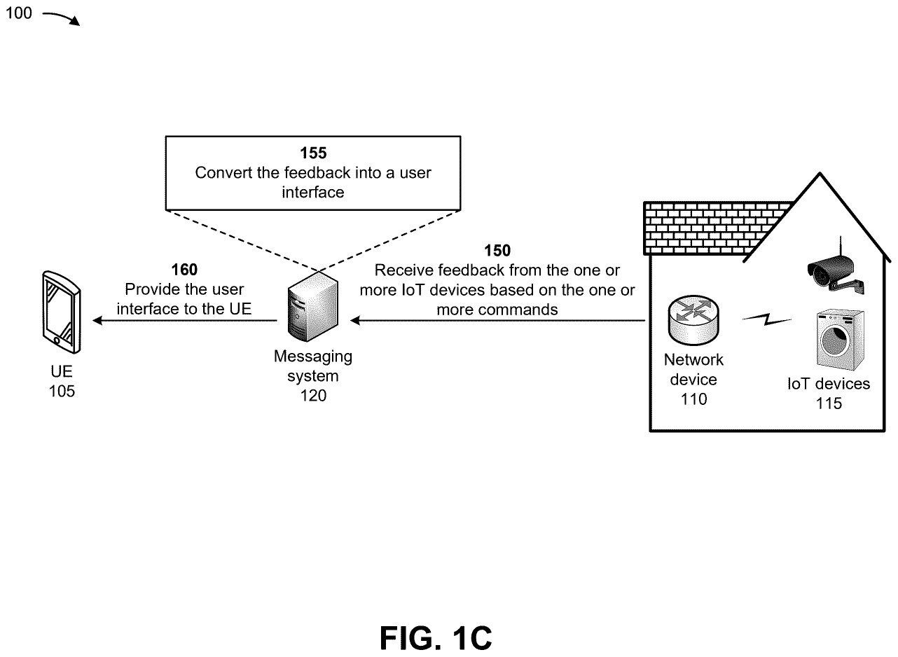

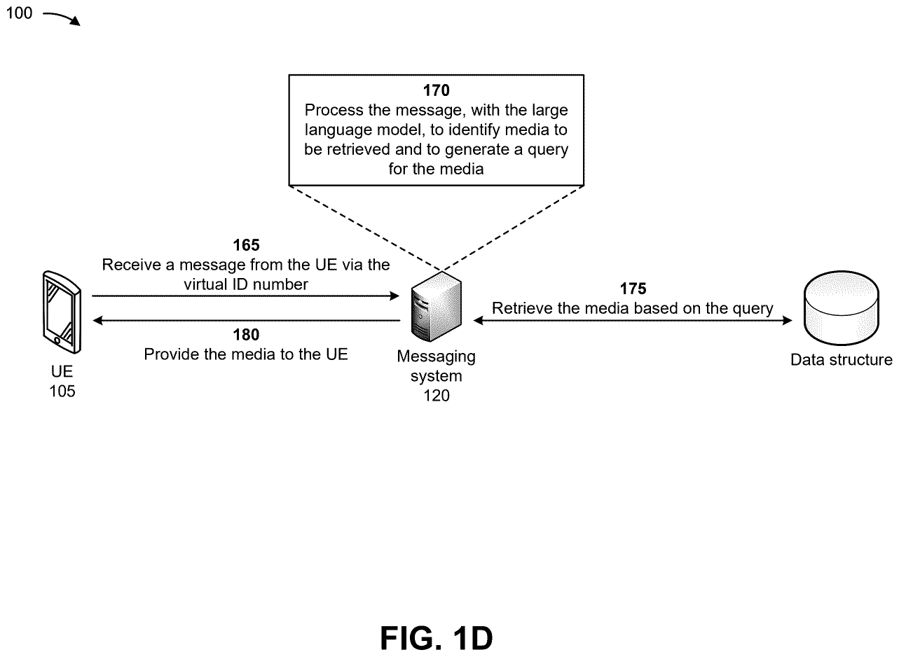

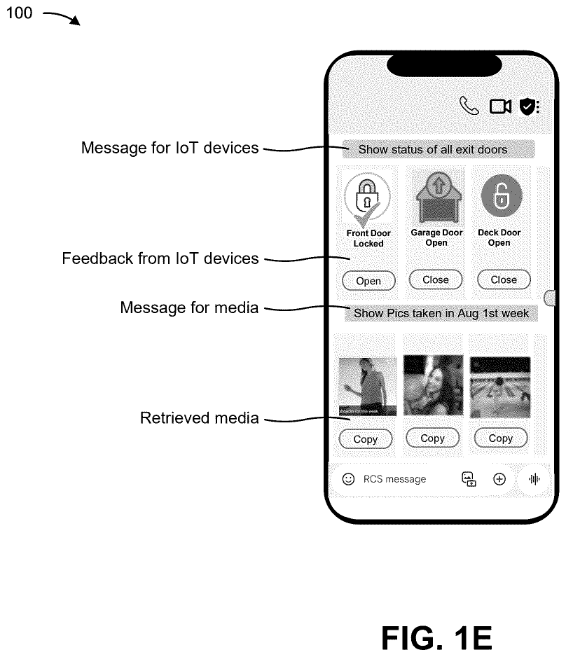

FIGS. 1A-1E are diagrams of an example 100 associated with utilizing text messages to interact with smart devices in plain language. As shown in FIGS. 1A-1E, the example 100 includes a UE 105, a network device 110, IoT devices 115, and a messaging system 120. Further details of the UE 105, the network device 110, the IoT devices 115, and the messaging system 120 are provided elsewhere herein. Although implementations described herein are related to IoT devices 115 and media, in some implementations, the messaging system 120 may be utilized with other applications and/or services, such as smart home management, cloud computing environment management, maintaining lists, setting reminders, managing and paying bills, managing rewards programs, managing security features, performing an Internet search, and/or the like.

As shown by FIG. 1A, and by reference number 125, the messaging system 120 may establish a virtual ID number associated with the UE 105. For example, the messaging system 120 may assign a unique virtual ID, such as a virtual phone number to the UE 105 so that the UE 105 may communicate with the messaging system 120 and the IoT devices 115 (e.g., via the network device 110 and the messaging system 120). The virtual ID, i.e., the virtual ID number may facilitate secure and streamlined interaction between a user of the UE 105 and the messaging system 120. In some implementations, the messaging system 120 may assign the virtual ID number (e.g., a unique identifier linking the user's text messages with associated IoT devices 115) or another identifier (e.g., a username, an account number, a password, and/or the like) to a user of the UE 105 and the IoT devices 115. In some implementations, the virtual ID number may be associated with the user, the UE 105, the network device 110, and/or the IoT devices 115 to ensure secure interactions between the user and the IoT devices 115 (e.g., via the UE 105).

The messaging system 120 may establish and manage virtual IDs and phone numbers, which are used to identify UEs 105 and facilitate secure communication. When the user initially registers the UE 105, the messaging system 120 may authenticate the user and may generate a virtual ID or phone number unique to a user account. The virtual ID number may be linked to the user's identity and associated IoT devices 115. The generation of the virtual ID number may include creating a unique identifier in a secure database, ensuring that the number cannot be easily duplicated or spoofed. The virtual ID number may utilize a hashing technique combined with a timestamp to provide uniqueness and reliability. A secure link may be established between the UE 105 and the messaging system 120 (e.g., using transport layer security (TLS) to encrypt the communication).

As further shown in FIG. 1A, and by reference number 130, the messaging system 120 may receive a message from the UE 105 via the virtual ID number. For example, the user may input a text message into the UE 105, and the UE 105 may transmit the text message to the messaging system 120 via the virtual ID number. The messaging system 120 may receive the text message from the UE 105. In some implementations, the text message may include a natural language text message, such as a command or a query related to controlling or retrieving information from the IoT devices 115. In some implementations, the UE 105 may utilize the rich communication services (RCS) protocol to generate and transmit the text message. The RCS protocol may provide enhanced messaging features, such as longer text messages, media sharing, read receipts, interactive buttons, and/or the like. This enriches user interactions, allowing more complex commands and richer feedback from the IoT devices 115, which are not feasible with basic short message service (SMS) or voice command systems.

In some implementations, the UE 105 may generate the text message with a messaging application and the text message may be utilized to interact with or control the IoT devices 115. Using the messaging application for IoT control commands may provide significant privacy and record-keeping advantages. For example, each interaction through the messaging application may be logged, allowing users to access a history of commands and the responses of the IoT devices 115. This may aid in managing and optimizing IoT device usage and may ensure that commands can be reviewed and corrected if necessary. Moreover, text-based interactions reduce privacy concerns inherent in voice commands, since text messages prevent eavesdropping and ensure that sensitive commands remain confidential.

In some implementations, the messaging system 120 may provide, to the UE 105, a unified messaging interface that integrates various services and/or applications. For example, the messaging system 120 may handle commands related to different services, which may enable users to interact with multiple applications through a single, streamlined interface. This may enable users to manage home automation, retrieve cloud-stored media, pay bills, set reminders, and/or the like, without switching between different applications.

In some implementations, the messaging system 120 may provide security authentication for the text message prior to processing the text message. For example, the messaging system 120 may validate the UE 105 or an identity of the user to ensure integrity of the text message and to prevent unauthorized access. The security authentication may include a subscriber identity module (SIM)-based authentication that ensures that only verified users and UEs 105 can interact with the messaging system 120.

For the security authentication, the messaging system 120 may utilize a combination of multi-factor authentication (MFA) and SIM-based authentication. Upon receiving a text message, the messaging system 120 may verify SIM card information of the UE 105 against the user's account details stored in a secure database. Additionally, a one-time password may be sent to the user's registered mobile number, which must be confirmed before any command is executed. The integration of these security measures ensures that only authorized users can control the IoT devices 115, thereby preventing unauthorized access.

The messaging system 120 may validate the text message by extracting metadata, such as timestamps and sender information, from the text message and creating a communication log. The messaging system 120 may analyze the communication log with anomaly detection models to filter out any irregularities or repeat attempts. Following this initial screening, the messaging system 120 may utilize cryptographic techniques to encrypt the commands and corresponding identifiers prior to transmission, ensuring secure end-to-end communication. Additionally, upon receiving feedback from the IoT devices 115, the messaging system 120 may execute integrity checks to validate that the feedback aligns with expected outcomes derived from the executed commands.

As shown by FIG. 1B, and by reference number 135, the messaging system 120 may process the message, with a large language model, to identify one or more IoT devices 115 and to generate one or more commands for the one or more IoT devices 115. For example, the messaging system 120 may translate the text message into the one or more commands, and may identify one or more IoT devices 115 associated with the one or more commands. In some implementations, the messaging system 120 may utilize an LLM to analyze the content of the text message and to identify relevant IoT devices 115 associated with the content of the text message. The LLM may interpret natural language instructions provided in the text message (e.g., “Raise the heat to 72 and turn on the lights”) and may convert the natural language instructions into specific commands that the identified IoT devices 115 can understand and execute. In some implementations, the messaging system 120 may utilize one or more other machine learning models to identify the one or more IoT devices 115 and to generate the one or more commands based on the text message received from the UE 105.

To implement the LLM for processing natural language text messages, the messaging system 120 may utilize a pre-trained LLM such as OpenAI's GPT-3 or similar models. This model may be fine-tuned specifically for IoT device control tasks by employing a diverse set of training data including various IoT commands, user queries, and their corresponding control actions. The fine-tuning process may include supervised learning where the LLM is trained on pairs of input commands and the corresponding IoT device actions. The LLM may be further optimized using reinforcement learning to improve performance in real-world scenarios, where feedback received from the IoT devices 115 may be utilized to iteratively improve the command generation accuracy of the LLM.

To initiate the fine-tuning of the LLM, the messaging system 120 may perform data preprocessing to transform raw IoT command logs into structured training data. This may include tokenizing the commands, identifying key phrases that denote specific actions, and categorizing the commands based on the types of IoT devices 115 they control. Subsequently, the LLM may be integrated into the messaging system 120 using a microservices architecture where the LLM is containerized (e.g., using Docker). The containerized LLM may communicate with the messaging system 120 via application programming interfaces (APIs), ensuring that the translation of text messages to IoT commands happens seamlessly. Continuous integration and deployment pipelines may be established to allow periodic updates and retraining of the LLM to adapt to evolving user commands.

As further shown in FIG. 1B, and by reference number 140, the messaging system 120 may provide the one or more commands to a network device 110 associated with the one or more IoT devices 115. For example, the messaging system 120 may transmit the one or more commands to the network device 110, which acts as an intermediary to relay the one or more commands to the appropriate IoT devices 115. In some implementations, the messaging system 120 may provide security authentication for the text message prior to providing the one or more commands to the network device 110. The security authentication may ensure that the one or more commands are legitimate and authorized, preventing unauthorized access or malicious attempts to manipulate the IoT devices 115. The security authentication may include verifying an identity of the user and/or the UE 105, performing message integrity checks, and other authentication protocols to safeguard communication channels with the IoT devices 115.

In some implementations, the messaging system 120 may identify specific IoT devices 115 relevant to received commands by accessing a pre-existing database that maps keywords and device identifiers. Upon identifying the correct IoT devices 115, the messaging system 120 may parse the command using a command interpreter module that standardizes different user request formats into a uniform command set understood by the IoT devices 115. For example, a user's text message “turn off the living room light” may be standardized into an API call to a light switch interface.

As further shown in FIG. 1B, and by reference number 145, the network device 110 may communicate with the one or more IoT devices 115 based on the one or more commands. For example, the network device 110 may ensure that the one or more commands are delivered using compatible communication protocols, thereby enabling seamless operation across different types of IoT devices 115. Once the network device 110 receives the one or more commands from the messaging system 120, the network device may initiate communication with the corresponding IoT devices 115 within a network supported by network device 110. The IoT devices 115 may perform one or more actions based on the one or more commands, such as adjusting settings of the IoT devices 115, retrieving data from the IoT devices 115, changing operational states of the IoT devices 115, and/or the like.

The network device 110 may support various communication protocols to ensure seamless interaction with diverse IoT devices 115. For transmitting commands, the network device 110 may utilize a message queuing telemetry transport (MQTT) protocol for lightweight communication with IoT devices 115, while supporting hypertext transfer protocol (HTTP) for IoT devices 115 that communicate through web protocols. The commands may be formatted in a JavaScript object notation (JSON) to provide a flexible, easily parsed structure. Each command may include metadata tags, such as device identification, command type, timestamp, and priority level, ensuring that the commands can be accurately processed and executed by the IoT devices 115. The messaging system 120 may include error-handling routines that provide feedback to the user in case of command execution failures, such as due to network issues or IoT device offline status.

As shown by FIG. 1C, and reference number 150, the messaging system 120 may receive feedback from the one or more IoT devices 115 based on the one or more commands. For example, the IoT devices 115 may perform one or more actions based on the one or more commands, and may generate the feedback based on performance of the actions. The feedback may include operational data of the IoT devices 115, status updates of the IoT devices 115, action acknowledgments by the IoT devices 115, and/or the like. The IoT devices 115 may provide the feedback to the network device 110, and the network device 110 may forward the feedback to the messaging system 120. The feedback may ensure that the messaging system 120 confirms the execution and status of the one or more commands provided to the one or more IoT devices 115.

As further shown in FIG. 1C, and by reference number 155, the messaging system 120 may convert the feedback into a user interface. For example, the messaging system 120 may transform raw data and status updates (e.g., the feedback) received from the one or more IoT devices 115 into a readable, user-friendly format. In some implementations, the messaging system 120 may aggregate the feedback, may format the aggregated feedback into coherent messages, and may generate interactive elements for the user interface based on the coherent messages. The user interface may include the text message provided by the user, a carousel for multiple items representing the one or more IoT devices 115, mechanisms for the user to provide input, hypertext markup language (HTML) content with hyperlinks, media content (e.g., images, file attachments, and/or the like), historical text messages provided by the user, and/or the like. The user interface may include rich text output that provides a comprehensive and visually engaging summary of the statuses and activities of the one or more IoT devices 115.

As further shown in FIG. 1C, and by reference number 160, the messaging system 120 may provide the user interface to the UE 105. For example, the messaging system 120 may cause the user interface to be displayed by the UE 105. The displayed user interface may enable the user to view near real-time statuses and feedback from the one or more IoT devices 115 in a clear and organized manner. In some implementations, the user interface includes mechanisms that, when selected by the user, may cause the UE 105 to generate commands for checking statuses and controlling operational states of the one or more IoT devices 115 (e.g., turn off the lights, close the garage door, lock the front door, and/or the like). This may ensure that the user can both monitor and effectively manage performance of the one or more IoT devices 115.

As shown by FIG. 1D, and by reference number 165, the messaging system 120 may receive a message from the UE 105 via the virtual ID number. For example, the user may input a text message into the UE 105, and the UE 105 may transmit the text message to the messaging system 120 via the virtual ID number. This may establish an initial communication between the UE 105 and the messaging system 120, and may facilitate translation and processing of content of the text message. In some implementations, the text message may include a natural language text message, such as a command or a query related to retrieving media from a data structure (e.g., a database, a table, a list, and/or the like) associated with the messaging system 120. In some implementations, the UE 105 may utilize the RCS protocol to generate and transmit the text message. The RCS protocol may provide enhanced messaging features, such as longer text messages, media sharing, read receipts, interactive buttons, and/or the like.

In some implementations, the UE 105 may generate the text message with a messaging application and the text message may be utilized to interact with the data structure. Using the messaging application for data structure retrieval commands may provide significant privacy and record-keeping advantages. For example, each interaction through the messaging application may be logged, allowing users to access a history of commands and the media retrieved from the data structure. This may aid in managing and optimizing media usage and may ensure that commands can be reviewed and corrected if necessary. Moreover, text-based interactions reduce privacy concerns inherent in voice commands, since text messages prevent eavesdropping and ensure that sensitive commands remain confidential.

In some implementations, the messaging system 120 may provide security authentication for the text message prior to processing the text message. For example, the messaging system 120 may validate the UE 105 or an identity of the user to ensure integrity of the text message and to prevent unauthorized access. The security authentication may include a SIM-based authentication that ensures that only verified users and UEs 105 can interact with the messaging system 120.

As further shown in FIG. 1D, and by reference number 170, the messaging system 120 may process the message, with the large language model, to identify media to be retrieved and to generate a query for the media. For example, the messaging system 120 may utilize an LLM to analyze the content of the text message and to identify relevant media resources, such as the data structure. The LLM may interpret the natural language instructions provided in the text message and may convert the natural language instructions into the query to retrieve the requested media from the data structure. In one example, the text message may request to “show pictures taken in the first week of August.” The LLM may parse the language of the text message and may generate a query that requests picture files (e.g., JPEG, TIFF, and/or the like) generated within date parameters (e.g., from Aug. 1, 2024 to Aug. 7, 2024).

As further shown in FIG. 1D, and by reference number 175, the messaging system 120 may retrieve the media based on the query. For example, the messaging system 120 may access a data structure storing the requested media and may retrieve the media identified by the query. This may include accessing databases or repositories where the media files are stored and extracting the necessary data. The data structure may receive the query, may identify the media requested by the query, and may provide the media to the messaging system 120. The messaging system 120 may receive the media from the data structure. In one example, the messaging system 120 may utilize the query to retrieve the pictures taken in the first week of August from the data structure.

As further shown in FIG. 1D, and by reference number 180, the messaging system 120 may provide the media to the UE 105. For example, the messaging system may transmit the retrieved media to the UE 105, and the UE 105 may display the media (or thumbnails of the media) to the user. This may ensure that the user receives the media requested in the text message, and that the user may view or utilize the media as needed.

FIG. 1E depicts an example user interface capable of being generated by the messaging system 120 and displayed by the UE 105. As shown, the user interface may include a text message generated for the IoT devices 115. For example, the text message may request showing statuses of all exit doors. The user interface may also include information indicating feedback from the IoT devices 115. For example, the feedback information may indicate that the front door is locked (with an option to open or unlock the front door), that the garage door is open (with an option to close the garage door), and that the back door is open or unlocked (with an option to close or lock the back door).

As further shown in FIG. 1E, the user interface may include a text message generated for retrieval of media. For example, the text message may request showing pictures taken in the first week of August. The user interface may also include the media or thumbnails of the media retrieved based on the text message. The media or the thumbnails may include options to copy the media to another application (e.g., an email application, an instant messaging application, and/or the like).

In one example, the implementations described herein may be provided via a universal messaging application associated with a small or medium business, such as a Restaurant. In such an example, a customer may input “scan a code to connect with the virtual ID of the restaurant,” “ask or search through the menu,” “browse through various items,” “place an order,” and/or the like.

In this way, the messaging system 120 utilizes text messages to interact with smart devices (e.g., the IoT devices 115) in plain language. For example, the messaging system 120 may identify IoT devices 115 associated with a text message received from a user of a UE 105, may transmit specific commands to the IoT devices, and may relay a current status or feedback of the IoT device directly to the UE. The messaging system 120 may translate the text message to the specific commands by utilizing an LLM, establishing a virtual ID number to securely authenticate user identity, and ensuring security checks for message authentication prior to execution of the specific commands. The messaging system 120 may provide a unified interface through standard RCS text messaging, and may enable streamlined control and management of diverse IoT devices 115. Thus, the messaging system 120 may conserve computing resources, networking resources, and/or other resources that would have otherwise been consumed by navigating through multiple mobile or desktop applications to control IoT devices 115, utilizing proprietary IoT device management systems that are difficult to understand and operate, and/or the like. By simplifying technological interactions within IoT device ecosystems through a common, accessible communication mode, the messaging system 120 may improve effectiveness and reduce technical complexities associated with IoT device management.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

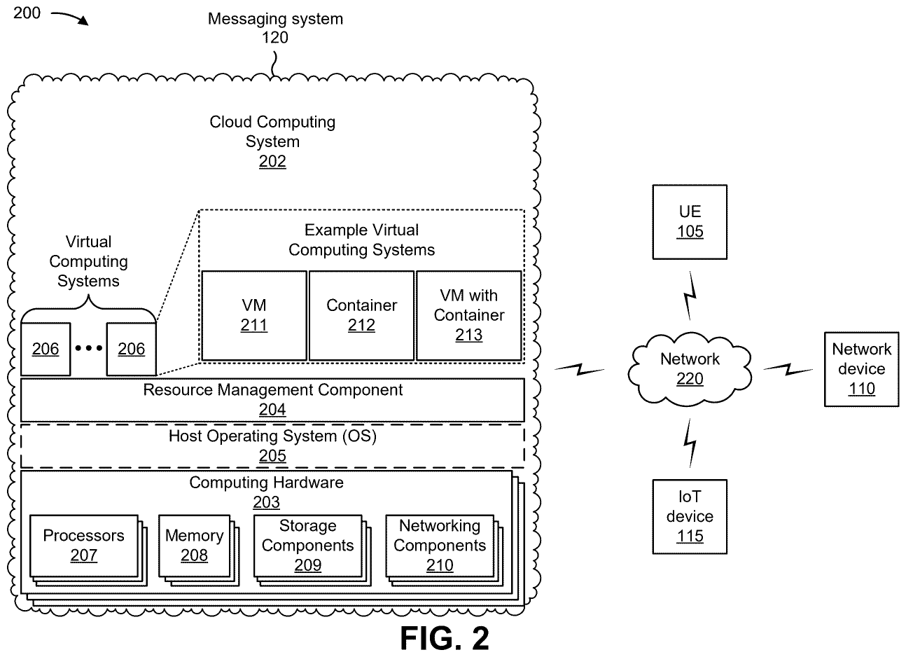

FIG. 2 is a diagram of an example environment 200 in which systems and/or methods described herein may be implemented. As shown in FIG. 2, the environment 200 may include the messaging system 120, which may include one or more elements of and/or may execute within a cloud computing system 202. The cloud computing system 202 may include one or more elements 203-213, as described in more detail below. As further shown in FIG. 2, the environment 200 may include the UE 105, the network device 110, the IoT device 115, and/or a network 220. Devices and/or elements of the environment 200 may interconnect via wired connections and/or wireless connections.

The UE 105 may include one or more devices capable of receiving, generating, storing, processing, and/or providing information, as described elsewhere herein. The UE 105 may include a communication device and/or a computing device. For example, the UE 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network device 110 may include one or more devices capable of receiving, processing, storing, routing, and/or providing traffic (e.g., a packet and/or other information or metadata) in a manner described herein. For example, the network device 110 may include a router, such as a label switching router (LSR), a label edge router (LER), an ingress router, an egress router, a provider router (e.g., a provider edge router or a provider core router), a virtual router, or another type of router. Additionally, or alternatively, the network device 110 may include a gateway, a switch, a firewall, a hub, a bridge, a reverse proxy, a server (e.g., a proxy server, a cloud server, or a data center server), a load balancer, and/or a similar device. In some implementations, the network device 110 may be a physical device implemented within a housing, such as a chassis. In some implementations, the network device 110 may be a virtual device implemented by one or more computing devices of a cloud computing environment or a data center. In some implementations, a group of network devices 110 may be a group of data center nodes that are used to route traffic flow through a network.

The IoT device 115 may include one or more devices capable of receiving, generating, storing, processing, and/or providing information, as described elsewhere herein. The IoT device 115 may include a communication device and/or a computing device. For example, the IoT device 115 may include a physical object embedded with sensors, software, and other technologies that enable the IoT device 115 to connect and exchange data with other devices and systems over the Internet or other communication networks. The IoT device may include a smart home device (e.g., a smart thermostat, a smart light, a smart lock, and/or the like), wearable technology (e.g., a fitness tracker, a smartwatch, and/or the like), an industrial IoT devices (e.g., a smart sensor, a smart meters, and/or the like), a healthcare device (e.g., a remote patient monitoring device, smart medical equipment, and/or the like), an environmental monitoring device (e.g., a weather stations, an air quality monitors, and/or the like), and/or the like.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

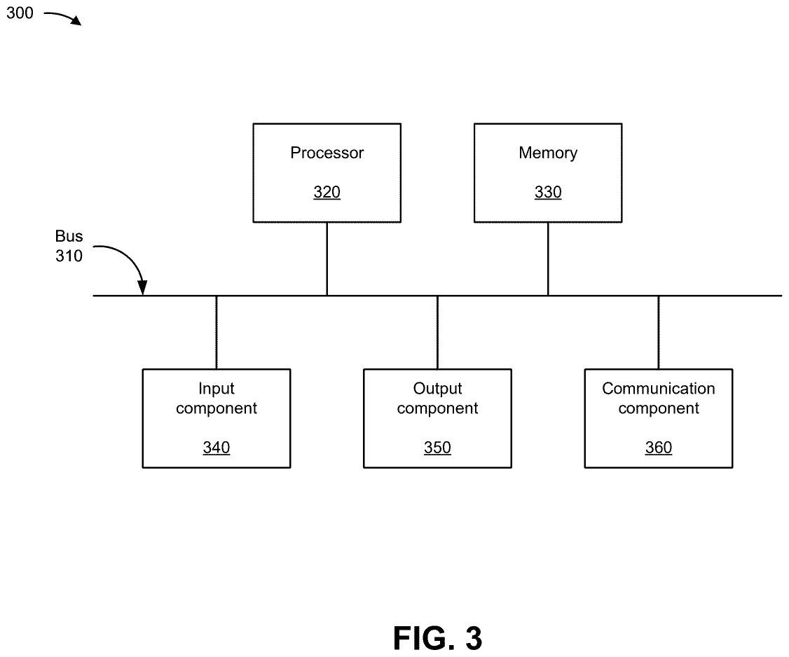

Although the messaging system 120 may include one or more elements 203-213 of the cloud computing system 202, may execute within the cloud computing system 202, and/or may be hosted within the cloud computing system 202, in some implementations, the messaging system 120 may not be cloud-based (e.g., may be implemented outside of a cloud computing system) or may be partially cloud-based. For example, the messaging system 120 may include one or more devices that are not part of the cloud computing system 202, such as the device 300 of FIG. 3, which may include a standalone server or another type of computing device. The messaging system 120 may perform one or more operations and/or processes described in more detail elsewhere herein.

The network 220 may include one or more wired and/or wireless networks. For example, the network 220 may include a cellular network (e.g., a 5G network, a 4G network, a long term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the UE 105, the network device 110, the IoT device 115, and/or the messaging system 120. In some implementations, the UE 105, the network device 110, the IoT device 115, and/or the messaging system 120 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

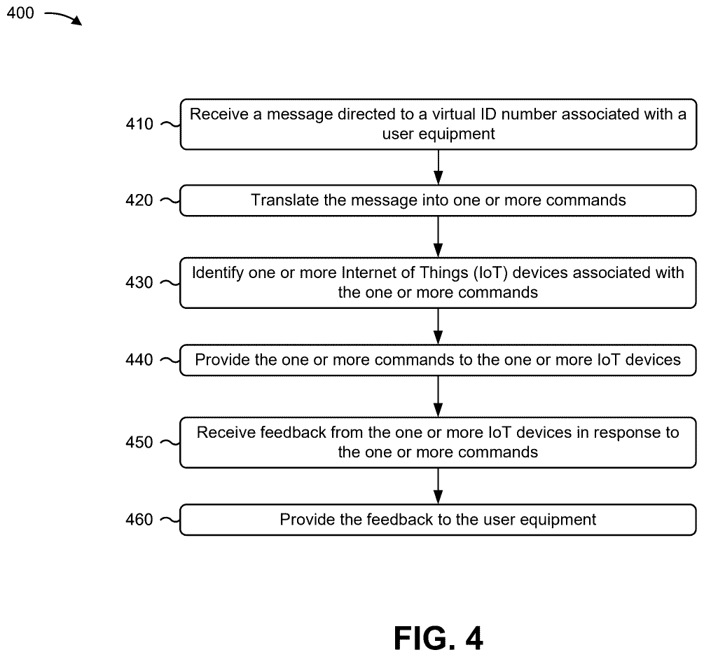

FIG. 4 is a flowchart of an example process 400 for utilizing text messages to interact with smart devices in plain language. In some implementations, one or more process blocks of FIG. 4 may be performed by a device (e.g., the messaging system 120). In some implementations, one or more process blocks of FIG. 4 may be performed by another device or a group of devices separate from or including the device, such as a UE (e.g., the UE 105) and/or a network device (e.g., the network device 110). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a message directed to a virtual ID, e.g., virtual ID number associated with a UE (block 410). For example, the device may receive a message directed to a virtual ID number associated with a UE, as described above. In some implementations, the message is a natural language text message provided via an RCS protocol.

As further shown in FIG. 4, process 400 may include translating the message into one or more commands (block 420). For example, the device may translate the message into one or more commands, as described above. In some implementations, translating the message into the one or more commands includes processing the message, with an LLM, to generate the one or more commands.

As further shown in FIG. 4, process 400 may include identifying one or more IoT devices associated with the one or more commands (block 430). For example, the device may identify one or more IoT devices associated with the one or more commands, as described above. In some implementations, the virtual ID number uniquely identifies a user associated with the UE and the one or more IoT devices. In some implementations, the one or more commands include commands to check statuses of the one or more IoT devices. In some implementations, the one or more commands include commands to control operational states of the one or more IoT devices.

As further shown in FIG. 4, process 400 may include providing the one or more commands to the one or more IoT devices (block 440). For example, the device may provide the one or more commands to the one or more IoT devices, as described above. In some implementations, providing the one or more commands to the one or more IoT devices includes providing the one or more commands to a network device associated with the one or more IoT devices, and causing the network device to relay the one or more commands to the one or more IoT devices using one or more protocols compatible with the one or more IoT devices.

As further shown in FIG. 4, process 400 may include receiving feedback from the one or more IoT devices in response to the one or more commands (block 450). For example, the device may receive feedback from the one or more IoT devices in response to the one or more commands, as described above. In some implementations, the feedback includes information regarding operational states of the one or more IoT devices. In some implementations, the feedback includes rich text output associated with the one or more IoT devices.

As further shown in FIG. 4, process 400 may include providing the feedback to the UE (block 460). For example, the device may provide the feedback to the UE, as described above.

In some implementations, process 400 includes establishing the virtual ID number for a user associated with the UE and the one or more IoT devices. In some implementations, process 400 includes providing security authentication for the message prior to providing the one or more commands to the one or more IoT devices.

In some implementations, process 400 includes receiving another message from the UE and via the virtual ID number, processing the other message, with an LLM, to identify media to be retrieved and to generate a query for the media, retrieving the media based on the query, and providing the media to the UE.

In some implementations, process 400 includes generating a user interface based on the feedback received from the one or more IoT devices, and providing the user interface, for display, to the UE.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a message directed to a virtual identification (ID) number associated with a user equipment;
translating, by the device, the message into one or more commands;
identifying, by the device, one or more Internet of Things (IoT) devices associated with the one or more commands;
providing, by the device, the one or more commands to the one or more IoT devices;
receiving, by the device, feedback from the one or more IoT devices in response to the one or more commands; and
providing, by the device, the feedback to the user equipment.

2. The method of claim 1, wherein the message is a natural language text message provided via a rich communication services protocol.

3. The method of claim 1, wherein the virtual ID number uniquely identifies a user associated with the user equipment and the one or more IoT devices.

4. The method of claim 1, wherein translating the message into the one or more commands comprises:
processing the message, with a large language model, to generate the one or more commands.

5. The method of claim 1, further comprising:
establishing the virtual ID number for a user associated with the user equipment and the one or more IoT devices.

6. The method of claim 1, wherein providing the one or more commands to the one or more IoT devices comprises:
providing the one or more commands to a network device associated with the one or more IoT devices; and
causing the network device to relay the one or more commands to the one or more IoT devices using one or more protocols compatible with the one or more IoT devices.

7. The method of claim 1, further comprising:
providing security authentication for the message prior to providing the one or more commands to the one or more IoT devices.

8. A device, comprising:
one or more processors configured to:
establish a virtual identification (ID) number for a user associated with a user equipment;
receive a message directed to the virtual ID number;
translate the message into one or more commands;
identify one or more Internet of Things (IoT) devices associated with the one or more commands;
provide the one or more commands to the one or more IoT devices;
receive feedback from the one or more IoT devices in response to the one or more commands; and
provide the feedback to the user equipment.

9. The device of claim 8, wherein the feedback includes information regarding operational states of the one or more IoT devices.

10. The device of claim 8, wherein the one or more processors are further configured to:
receive another message from the user equipment and via the virtual ID number;
process the other message, with a large language model (LLM), to identify media to be retrieved and to generate a query for the media;
retrieve the media based on the query; and
provide the media to the user equipment.

11. The device of claim 8, wherein the feedback includes rich text output associated with the one or more IoT devices.

12. The device of claim 8, wherein the one or more commands include commands to check statuses of the one or more IoT devices.

13. The device of claim 8, wherein the one or more commands include commands to control operational states of the one or more IoT devices.

14. The device of claim 8, wherein the one or more processors are further configured to:
generate a user interface based on the feedback received from the one or more IoT devices; and
provide the user interface, for display, to the UE.

15. A non-transitory computer-readable medium storing a set of instructions, the set of instructions comprising:
one or more instructions that, when executed by one or more processors of a device, cause the device to:
receive a message directed to a virtual identification (ID) number associated with a user equipment (UE);
translate the message into one or more commands;
identify one or more Internet of Things (IoT) devices associated with the one or more commands;
provide the one or more commands to the one or more IoT devices;
receive feedback from the one or more IoT devices in response to the one or more commands,
wherein the feedback includes information regarding operational states of the one or more IoT devices; and
provide the feedback to the user equipment.

16. The non-transitory computer-readable medium of claim 15, wherein the message is a natural language text message provided via a rich communication services protocol.

17. The non-transitory computer-readable medium of claim 15, wherein the one or more instructions, that cause the device to translate the message into the one or more commands, cause the device to:
process the message, with a large language model, to generate the one or more commands.

18. The non-transitory computer-readable medium of claim 15, wherein the one or more instructions further cause the device to:
establish the virtual ID number for a user associated with the UE and the one or more IoT devices.

19. The non-transitory computer-readable medium of claim 15, wherein the one or more instructions, that cause the device to provide the one or more commands to the one or more IoT devices, cause the device to:
provide the one or more commands to a network device associated with the one or more IoT devices; and
cause the network device to relay the one or more commands to the one or more IoT devices using one or more protocols compatible with the one or more IoT devices.

20. The non-transitory computer-readable medium of claim 15, wherein the one or more instructions further cause the device to:
receive another message from the UE and via the virtual ID number;
process the other message, with a large language model, to identify media to be retrieved and to generate a query for the media;
retrieve the media based on the query; and
provide the media to the user equipment.
